(19) United States
(12) Patent Application Publication
(10) Pub. No.: US 2017/0206538 A1
(43) Pub. Date: Jul. 20, 2017

(54) Method for Determining a Convergence Measure for Converging an Allocation Position of a Subject Allocations Provider Towards a Desired Allocation Position

(71) Applicant: MASTERCARD INTERNATIONAL INCORPORATED, Purchase, NY (US)

(72) Inventor: Amit Gupta, New Delhi (IN)

(21) Appl. No.: 15/405,537

(22) Filed: Jan. 13, 2017

(30) Foreign Application Priority Data
Jan. 14, 2016 (SG) 10201600302Q

(51) Int. Cl. G06Q 30/02; G06Q 50/14

(52) U.S. Cl. CPC G06Q 30/0202; G06Q 50/14

(57) ABSTRACT

Disclosed is a system and method for determining a convergence measure for converging an allocation position of a subject allocations provider towards a desired allocation position. The method comprises receiving itinerary data comprising route information and an indicative departure time and identifying conforming allocations from a plurality of allocations represented by transaction level data. The method also involves determining the allocation position for the subject allocations provider and an allocation position of other allocations providers based on the conforming allocations, and comparing the allocation position of the subject allocations provider to the allocation position of at least one of the other allocations providers to identify at least one convergence measure for adjusting one or more parameters of an allocations offering associated with the subject allocations provider so that the allocation position of the subject allocations provider converges towards the desired allocation position.

### CROSS-REFERENCE TO RELATED APPLICATION

This application claims the benefit of and priority to Singapore Patent Application No. 10201600302Q, filed Jan. 14, 2016. The entire disclosure of the above application is incorporated herein by reference.

### FIELD

The present disclosure relates broadly, but not exclusively, to methods for determining a convergence measure for converging an allocation position of a subject allocations provider towards a desired allocation position. The present disclosure may be applied, with prejudice to other applications of the disclosure, to adjusting forecast airline seating allocations and market share.

### BACKGROUND

This section provides background information related to the present disclosure which is not necessarily prior art.

Comparisons and forecasts are used in many fields. They provide tools by which parties, such as airlines, merchants, marketers and researchers, can determine where a particular party is positioned in a market (e.g. the market share of that party) and determine the changes that may occur to that party's position in the market over time.

There exist tools for forecasting a party's position in a market. These tools typically rely on current figures and historical trends. They often do not take into account peripheral influences such as changes in consumer behaviour or methods to effect such changes, and competitive management of the party's offering to consumers in order to meet specific goals.

As a result, forecasting remains a very inexact science.

A need therefore exists to provide further methods for determining ways for a party to change its position in a market and also to adjust uptake of its offering to consumers to meet relatively market independent objectives.

### SUMMARY

This section provides a general summary of the disclosure, and is not a comprehensive disclosure of its full scope or all of its features. Aspects and embodiments of the disclosure are also set out in the accompanying claims.

The present disclosure provides a method for determining a convergence measure for converging an allocation position of a subject allocations provider towards a desired allocation position, the method comprising:
receiving itinerary data comprising route information and an indicative departure time;
identifying one or more conforming allocations from a plurality of allocations represented by transaction level data, wherein:
   each allocation is associated with a respective allocations offering;
   each allocations offering comprises a plurality of parameters including allocation itinerary data and an associated allocations provider, and the allocation itinerary data comprises allocation route information and a departure time;
   each allocation comprises at least three parameters derived from the parameters of the respective allocations offering, the at least three parameters including the transaction amount, allocation itinerary data and allocations provider;
   the transaction amount, allocation itinerary data and allocations provider are derivable using the transaction level data; and
   each conforming allocation comprises allocation route information and departure time matching the route information and indicative departure time of the itinerary data;
determining the allocation position for the subject allocations provider and an allocation position of one or more other allocations providers based on the one or more conforming allocations; and
comparing the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position.

The following terms will be given the meaning provided here, in the absence of context dictating use of a different meaning:
“allocation” refers to a reservation made by a consumer for occupying a position on a vehicle, such as an aeroplane or aircraft. The term “allocation” may be referred to as a “seating allocation”, “seating reservation”, “ticket”, “seat”, “booking” and similar in the ensuing detailed description.
“allocations provider” refers to a provider of allocations. The allocations provider may be an owner or operator of the vehicle on which an allocation is made for example, and airline may be the owner of an aircraft or aeroplane on which a seating reservation is made. A “subject allocations provider” is thus a particular allocations provider in respect of which analysis is being conducted in accordance with the methods taught herein.
“allocation position” refers to one or more parameters, discussed below, relating to the occupancy of allocations on a vehicle. For example, the allocation position of an airline may be that 50% of the available seating on a particular route, for a particular indicative time, has been purchased by consumers.
“desired allocation position” refers to the allocation position an allocations provider would like to achieve. The desired allocation position may be specified by reference to a fixed date. For example, where the desired allocation position is full occupancy of an aircraft, that full occupancy may be desirably reached on the date on which the aircraft is set to leave an airport (i.e. the departure date). The desired allocation position may be specified as a desired occupancy rate (e.g. the percentage of total tickets sold of the tickets available on a particular aircraft or fleet of aircraft), desired profitability per allocation, market share, share of consumer spend and any other parameter an allocations provider would like to use to define a desired position relative to their current position.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the disclosure will now be presented, by way of non-limiting example only, with reference to the accompanying drawings in which:

FIG. 1 shows a computer-implemented method or process, in accordance with one embodiment of the disclosure, for determining a convergence measure for converging an allocation position of a subject allocations provider towards a desired allocation position.

FIG. 2 depicts the comparative allocation positions between allocations providers.

FIG. 3 shows an example of pricing trend data and seating reservation data for a typical airline, with reference to the date of booking relative to the date of departure.

FIG. 4 illustrates a graphical method for determining flight routes on which the methods described herein may be particularly advantageously applied.

FIG. 5 shows a schematic of a system for performing the method of FIG. 1.

FIG. 6 shows an exemplary computing device suitable for executing the method of FIG. 1.

FIG. 7 shows a data flow for the process set out in relation to FIG. 1.

### DETAILED DESCRIPTION

Embodiments of the present disclosure will be described, by way of example only, with reference to the drawings. The description and specific examples included herein are intended for purposes of illustration only and are not intended to limit the scope of the present disclosure. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a general-purpose computer effectively results in an apparatus that implements the steps of the preferred method.

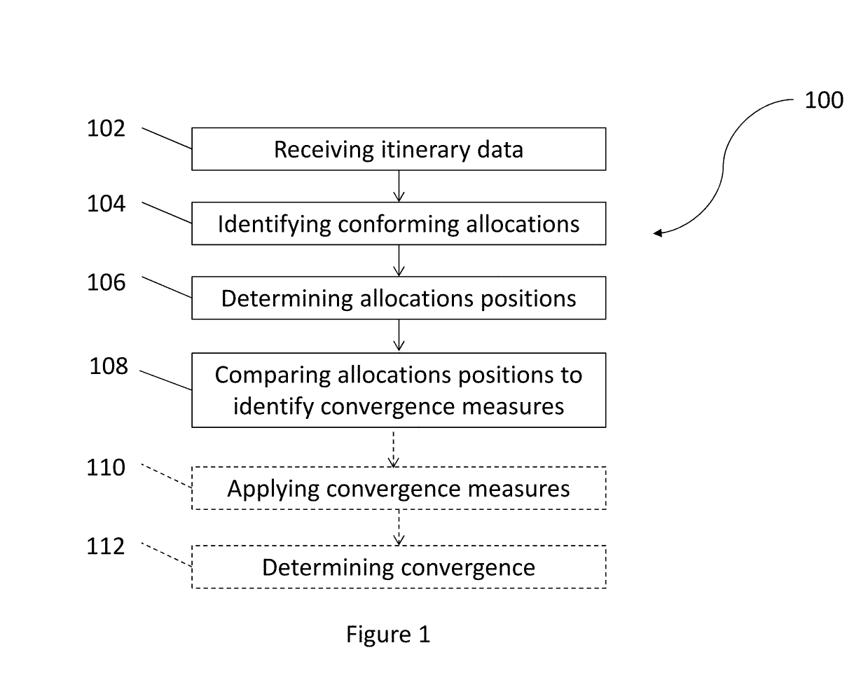

FIG. 1 shows a computer-implemented method or process 100, in accordance with one embodiment of the disclosure, converging an allocation position of a subject allocations provider, hereinafter interchangeably referred to as a “subject airline” or “subject carrier”, towards a desired allocation position. The predicted impact is to facilitate the planning of product related activities referred to as “allocations offerings” or “offerings”. Allocations offerings are consumer-directed marketing campaigns, advertising and related activities by which an allocations provider may attract consumers. The method broadly comprises the steps of:
Step 102: receiving itinerary data;
Step 104: identifying conforming allocations;
Step 106: determining allocation positions; and
Step 108: comparing allocation positions to identify convergence measures.

Further optional steps are shown in broken lines and include:
Step 110: applying convergence measures.
Step 112: determining convergence.

In step 102, itinerary data is received. The itinerary data comprises route information, for a flight route of an aircraft, between a port of origin and a destination port. The itinerary information also includes an indicative departure time of that aircraft from the port of origin.

The itinerary data may also include one or more of the class of a particular allocation (e.g. economy class, business class or first class), baggage allowances, upgrades, and other features relating to a reservation. The itinerary data may also include benefits, such as those provided in accordance with loyalty schemes (e.g. Krisflyer® and Frequent Flyer®).

The itinerary data forms the basis upon which the subsequent method steps are carried out. In particular, in the subsequent steps allocations are identified that match the itinerary data so that allocation positions of various allocations providers (e.g. airlines or carriers) can be assessed.

In step 104, conforming allocations are identified from transaction level data. It will be appreciated that in some instances there may be no conforming allocations, in other instances there may be one conforming allocation, and in further instances there may be two or more conforming allocations. Where a flight has been made available for bookings in the immediate past, for example, it may be that there is insufficient time for any, or many, bookings to have been made before the method of FIG. 1 is performed. As the departure time approaches, it is envisaged that a greater number of conforming allocations will be made.

The transaction level data comprises transactions that represent ticket purchases on a particular airline. The transaction level data may include a number of parameters or may be associated with a number of parameters. For example, a parameter directly reflected by transaction level data would be the transaction or ticket amount (i.e. purchase price) of a ticket. A parameter associated with the transaction level data may be itinerary information that can be mapped to a particular transaction. For parameters that are not directly reflected in transaction level data, a database of seating allocations may be cross-referenced against the transaction level data thereby to obtain the relevant parameters. Thus each such parameter, whether directly reflected in the transaction level data or associated with it, is derivable from that data.

Transaction level data may include past purchase data of one or more tickets, and may also include purchases associated with goods or services (e.g. meal upgrades) that are related to the ticket purchase. Thus, the transaction level data may not be confined to solely the purchase of an allocation or seat on an aircraft. Instead, in addition to the purchase of an allocation or ticket on an aircraft, the transaction level data may also represent one or more of the following: seating upgrades; use of loyalty rewards points; prizes that include airfares (such transactions may have a zero dollar amount yet result in an allocation being made a prize equivalent dollar amount may then be used in the methods described herein); entertainment system rental; package deals (e.g. purchases of allocations and associated accommodation, trips, and other packaged items); and meal upgrades.

The transaction level data may be extracted from an enterprise data warehouse. The enterprise data warehouse may be populated with data comprising any one or more of credit card transactions, debit card transactions or stored-value card transactions. These credit card, debit card or stored-value card transactions may include the following types of transaction level data in addition to those discussed above:

Transaction Information:
Transaction ID
Account ID
Merchant ID
Transaction Amount
Transaction Local Currency Amount
Date of Transaction
Time of Transaction
Type of Transaction
Date of Processing
Merchant Category Code (MCC)

Account Information (i.e. information about the account holder of the credit card, debit card or stored-value card):
Account ID (which may be anonymized)
Card Group Code
Card Product Code
Card Product Description
Card Issuer Country
Card Issuer ID
Card Issuer Name

Merchant Information:
Merchant ID
Merchant Name
MCC/Industry Code (which may include travel agencies as well a direct bookings with a particular carrier)
Industry Description
Merchant Country
Merchant Address
Merchant Postal Code
Merchant Acquirer ID (i.e. the identity of the financial institution that pays the merchant when a purchase is made)

Issuer Information (i.e. information about the financial institution that has provided or issued the credit card, debit card or stored-value card):
Issuer ID
Issuer Name
Issuer Country

The allocation itinerary data may be determined, for example, by mapping the transaction ID and/or merchant ID to particular itineraries and indicative departure times for the same transaction ID and/or merchant ID of a transaction recorded by an airline in the enterprise data warehouse.

In addition to the above transaction data, the past purchase data may also comprise data obtained from merchant sales records. Data from merchant sales records may be obtained from a database connected to a payment processing terminal which captures the past purchase. Alternatively, the past purchase data may be obtained from hard copies converted into electronic form. The past purchase data may also comprise data sorted into different merchant categories, such as corporate bookings service providers (i.e. corporate travel management agencies) and commercial bookings services providers (e.g. travel agents), wherein the past purchase data may then be filtered by merchant category.

Each allocation identified in the transaction level data, conforming or otherwise, is associated with a respective allocations offering. For example, where an airline offers seats for sale on a particular route for a particular departure time (e.g. time of departure on a particular date), all allocations made during the period of that offering can be associated with the offering. Similar associations can be made for reservations made during the offer period, where those reservations are confirmed (i.e. paid for) after expiry of the offer period, provided the parameters of the offer (e.g. route and departure time and date) apply to the allocation thereby made.

Each allocations offering thus comprises a plurality of parameters including allocation itinerary data (i.e. allocation route information and departure time) and is associated with an allocations provider. Allocation itinerary data may also include a transaction amount for making the allocation, though this may similarly be derived from other parameters of the transaction level data. In other words, the transaction level data may comprise data from which the allocation itinerary can be identified, and additional information, including the transaction amount. Notably, the transaction amount may include additional costs, such as would be incurred for package deals, extra baggage allowance and the like, as mentioned above.

To enable analysis of allocation positions, each allocation position being a statistical description of the sales and relative position of the airline in the group of airlines servicing having flights that match the itinerary data, each allocation comprises at least three parameters. The parameters are derived from the parameters of the respective allocations offering and include the transaction amount, allocation itinerary data and allocations provider. The parameters may further include whether or not upgrades have been applied, the type of upgrade, specific meals and other characteristics previously specified in relation to transaction level data.

The parameters necessary for each allocation may depend on the nature of the comparison being performed in accordance with the present methods. For example, where the comparison is limited to a particular class of ticket, then each allocation should include a class parameter by which to determine whether or not it is relevant to a particular comparison.

The allocations are separated in conforming allocations and non-conforming allocations on the basis of their parameters. As a minimum, each conforming allocation comprises allocation route information and departure time that match the itinerary information and indicative departure time of the itinerary data.

A “match” between allocation route information and route information of the itinerary data received under step 102 may be an exact match. In other words, the routes have the same port of origin and destination port, with the same stopovers, if any. The match may be inexact where, for example, a city has more than one airport so that routes have very similar, but not the same, port of origin or destination port. Inexact matches can be used where a consumer would consider, for example, either port of origin or destination port in the same city to be similarly desirable as a start or end of a journey.

A “match” between the indicative departure time of the itinerary data received under step 102, and the departure time of an allocation in question, may be an exact match. For example, the indicative departure time may be 13:30 on 16 Jul. 2015 and the departure time of the allocation may be 13:30 on 16 Jul. 2015. Alternatively a match may be inexact where, for example, the indicative departure time is specific as a range (e.g. 12:00 to 14:00 on 16 Jul. 2015, or 15/16 Jul. 2015), includes a tolerance (e.g. plus or minus an hour from a specific departure time) or includes travel periods, such as peak and off-peak periods including daily or seasonal peak and off-peak periods.

In step 106, allocation positions of various carriers are determined. To facilitate identification of convergence measures, the allocation position of the subject carrier and at least one other carrier are determined. The subject carrier is the carrier for whom the convergence measures are being identified so as to bring the allocation position of that carrier towards the desired allocation position.

The nature of the allocation position may be determined by reference to the particular objectives of the subject carrier. For example, where the subject carrier desires to have full occupancy of seats on a particular flight travelling a particular route at a particular time (i.e. date and time of travel), then the allocation position will necessarily represent the percentage of tickets booked of the relevant available tickets for that carrier. Where the subject carrier desires to have increased market share (i.e. higher percentage of overall ticket sales for the particular flight route and time) then the allocation position will necessarily represent the percentage of the number of tickets sold by the subject carrier relative to the number of tickets sold by other carriers for the relevant route and time.

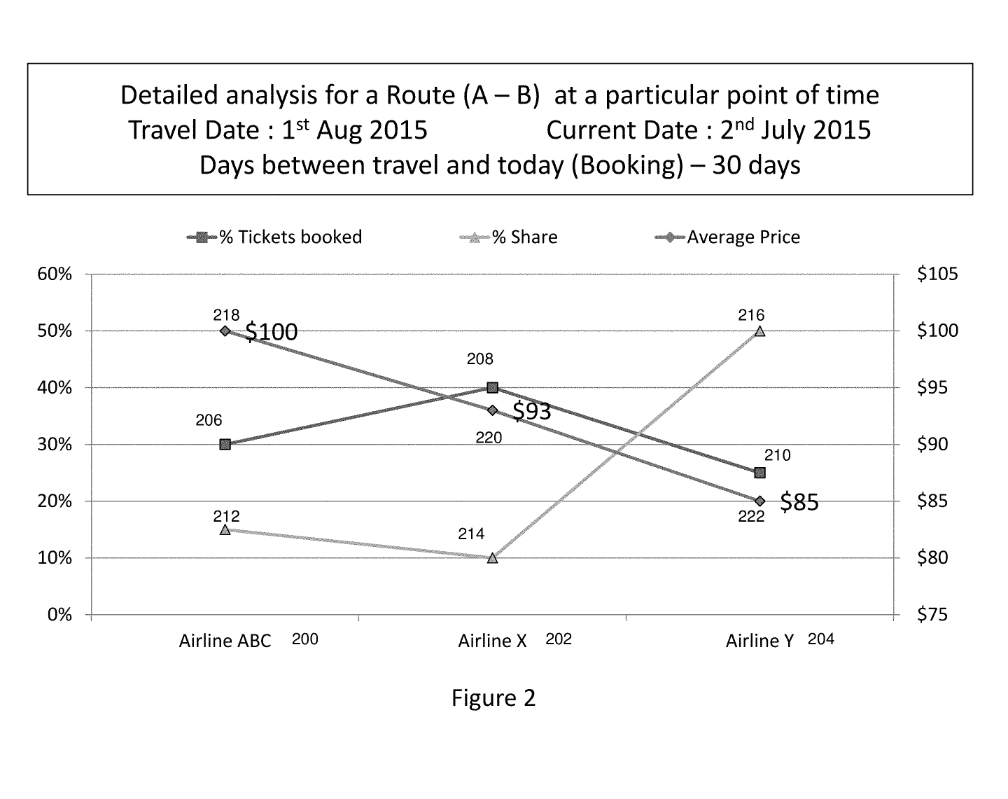

An allocation position may be a snapshot of current parameters (i.e. overall occupancy or market share) at a particular point in time. That snapshot may show the allocation position of the subject carrier relative to the allocation positions of other carriers. With reference to FIG. 2, such a snapshot is shown in which the comparative allocation positions between allocations providers are illustrated. The snapshot is taken on 2 Jul. 2015, for a departure time of 1 Aug. 2015. The departure time may be more specific, where desired, such as 13:30, 1 Aug. 2015.

FIG. 2 shows the relative allocation positions based on 30 days to travel. Thus any convergence measures should be determined based on achieving convergence of the allocation position of the subject carrier to the desired allocation position by the travel date of 1 Aug. 2015.

The subject allocations provider of carrier is shown as Airline ABC (200), against the allocation positions of Airline X (202) and Airline Y (204). The allocation position comprises:
an indication of the percentage of tickets booked, referenced as:
   206 for Airline ABC (200);
   208 for Airline X (202); and
   210 for Airline Y (204);
an indication of the market share of each airline, referenced as:
   212 for Airline ABC (200);
   214 for Airline X (202); and
   216 for Airline Y (204); and
an indication of the average ticket price for allocations made with each respective airline, reference as:
   218 for Airline ABC (200);
   220 for Airline X (202); and
   222 for Airline Y (204).

The term “indication” is used since exact numbers of allocations may not be known where, for example:
(i) travel agents send sales of allocations in batches to an airline,
(ii) a ticket price shown in transaction data is very large and may be a transaction relating to purchase of more than one ticket but the exact number of tickets uncertain,
(iii) taxes incurred by a particular airline are not known, or
(iv) where a particular airline adjusted its pricing policy and it is unclear whether a particular transaction relates to a purchase made before or after that adjustment.

From FIG. 2 it is apparent that Airline ABC, the subject allocations provider, has a higher average ticket price than Airlines X and Y. It is also apparent that Airline ABC has a higher market share than Airline X, but lower market share than Airline Y. While it may be assumed that ticket sales for the same itinerary data should favour airlines with lower ticket prices, some airlines are highly profitable based on perceived service level (e.g. attentive cabin crew), prestige when compared with budget airlines, type or size of aircraft, and customer loyalty. The fact that Airline ABC has higher market share, in other words, has sold more tickets to 2 Jul. 2015, than Airline X, despite Airline X having lower average ticket prices, suggests that other market factors are influencing consumer decisions. Thus an airline with lower market share and higher average ticket prices may be more profitable, or have a more secure profit, than an airline with higher market share that relies on high passenger throughput to maintain profitability. Moreover, the optimisation of profit may not be directed to market share or occupancy rates.

With further reference to FIG. 2, Airline X also has a higher percentage of tickets booked than Airline ABC despite having lower market share. This means that Airline X has fewer tickets available and may be optimising seat sales rather than aiming for highest profit per seat sold.

Similarly, Airline Y has the highest market share despite having the lowest percentage of tickets booked. Airline Y therefore has a larger allocations capacity than either of Airlines ABC and X. The low average ticket price for Airline Y suggests it generates profit based on high throughput, in a similar manner to many budget airlines.

Snapshots such as that shown in FIG. 2 can provide a significant amount of information about an airline and its competitors. In line with the above analysis, FIG. 2 shows the relationship between pricing and fleet size, Airline Y is likely to be a budget airline whereas Airline X is likely to be a boutique airline, and suggests ways of adjusting an allocations offering to change the allocation position of a particular airline. Where the allocations offering is a marketing campaign, and Airline ABC is endeavouring to increase ticket sales, FIG. 2 suggests that lowering prices is one method of achieving higher sales. However, the similar market share between Airlines ABC and X also suggests that for non-budget carriers the price point should not be too low (e.g. not as low as that average price for tickets booked on Airline Y) since the percentage of tickets booked will rapidly approach full capacity which suggests that ticket prices could have been higher and still have reached capacity by 1 Aug. 2015.

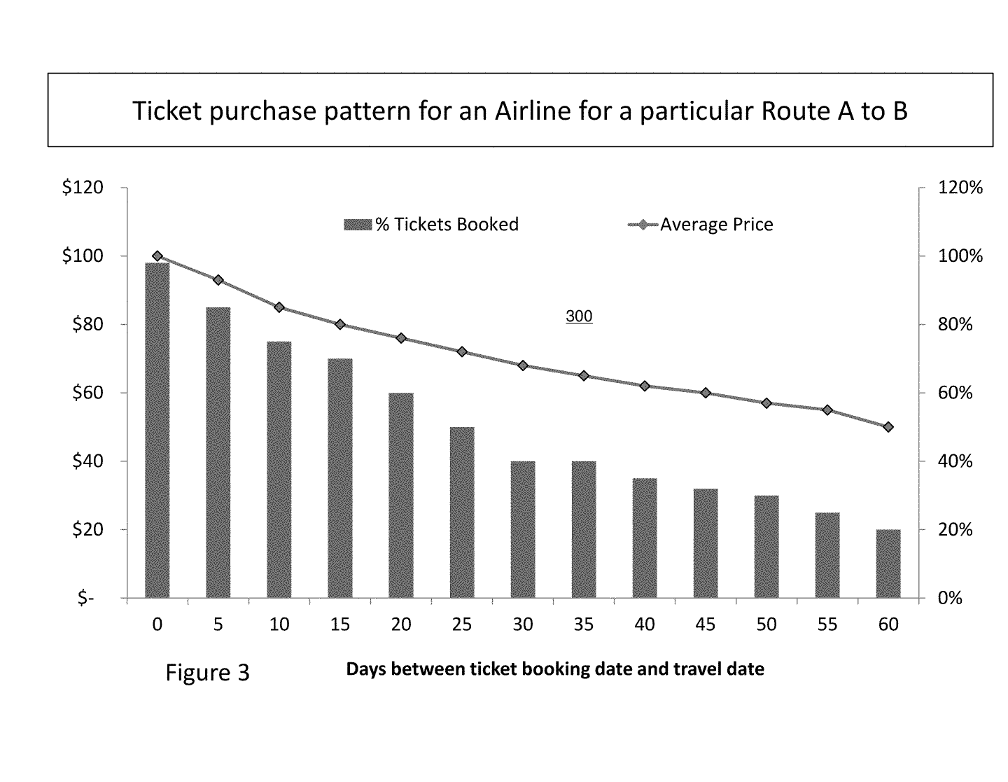

With further reference to FIG. 1, step 108 involves comparing the allocation position of the subject allocations provider, Airline ABC, to the allocation position of at least one of the one or more other allocations providers, Airlines X and Y, to identify at least one convergence measure. The convergence measure or convergence measures are used to adjust one or more parameters of an allocations offering to achieve a desired change in the allocation position of the subject allocations provider. Where the subject allocations provider makes an allocations offering, such as offering allocations at a particular price, the allocation position of the allocations provider is readily calculated. Similarly, based on historical data, such as that shown in FIG. 3, the allocation position of the allocations provider at the departure time can be estimated or forecast. If that estimated or forecast allocations position is different to the desired allocation position, the convergence measure or convergence measures can be applied so that the allocation position of the subject allocations provider converges towards the desired allocation position. Such a convergence measure may be a ticket price reduction to increase the rate at which allocations are consumed (i.e. sold) by consumers. Such a convergence measure may be a ticket price reduction based on a comparison between the current ticket price associated with a current allocations offering and a ticket price of a different airline with an allocation position that more closely approximates the desired allocation position in at least one parameter (e.g. number of tickets sold or market share), and identifying a ticket price that is closer to the ticket price of the different airline.

Importantly, some of the parameters of an allocation position are market-related and some are market-unrelated. For example, market share is market-related since it is a measure of the position of one airline relative to one or more other airlines. Contrastingly, percentage of tickets sold is market-unrelated since it relates to the number of tickets sold by an airline relative to the total number of tickets it has for sale, even though it may be influenced by the allocations offerings of other allocations providers. Thus market-related parameters can effect market-unrelated parameters and vice versa. Similarly, a convergence measure applied to one parameter can affect other parameters. For example, an increase in ticket price may increase profitability per seat but reduce seat sales. For some providers, an increase in ticket price above a threshold may result in the perception that service levels on the airline are superior to those of a lower cost provider, thus increasing ticket sales and profitability per seat. In this manner, convergence measures may take into account consumer perception.

A convergence measure may be any factor that is intended to converge the current allocation position of an allocations provider towards a desired allocations position. For example, a convergence measure may be a higher investment in staff cabin crew training. This may result in a better level of service provided by cabin crew, thereby resulting in an ability for Airline ABC to maintain ticket price yet increase ticket sales based on perceived service level. Another convergence measure may be the provision of additional baggage allowances. When compared with budget airlines that may have minimal baggage allowance, and thus charge a large fee for excess baggage, the gap between the ticket price for the budget airline and the ticket price for Airline ABC may be perceived to be narrower on the basis that a similar luggage allowance on the budget airline would result in substantial additional charges above the ticket price for the seat alone.

In line with FIG. 2, comparison step 108 may be performed by determining a number of conforming allocations (ticket sales with matching itinerary data) for each allocations provider and comparing the number of conforming allocations for the subject allocations provider against the number of conforming allocations for the at least one of the one or more other allocations providers. This may be achieved by representing the number of conforming allocations by the ratio of conforming allocations for the respective allocations provider to the total available conforming allocations for all allocations providers. In effect, this is a market share comparison. Thus, in this example, a parameter of the desired allocation position must be the market share. The comparison being performed should be based on the desired outcome or change necessary to reach the desired allocation position.

In line with FIG. 2, comparison step 108 may alternatively, or in addition, be performed by comparing a percentage share of total conforming allocations for the subject allocations providers against a percentage share of total allocations for one or more other allocations providers. This comparison compares the total occupancy of each respective airline, whether or not that airline has a fleet of aircraft or a single aircraft, and regardless of the size of that or those aircraft.

Again, in line with FIG. 2, where the transaction amount comprises a ticket price, the comparison step 108 may be performed by comparing an average ticket price for all conforming allocations for the subject allocations provider to an average ticket price for all conforming allocations for the at least one of the one or more other allocations providers. This comparison may show that ticket prices and sales numbers are not inversely proportional, or that other factors, such as consumer perception, brand loyalty and the like, have an influence on ticket sales. Thus a convergence measure formulated based on this comparison may rely on consumer perception along with pricing allocations to fit with that consumer perception. Notably, simply lowering ticket prices may not result in higher sales as shown by the lower sales of allocations with Airline X in FIG. 2 when compared with allocations with Airline ABC, despite Airline X having lower average ticket prices when compared with Airline ABC.

Step 110 involves applying the convergence measure or convergence measures to the allocations offering associated with the subject allocations provider. In other words, an airline may put out a marketing campaign (allocations offering) to which the convergence measures are applied so that the allocation position of the airline converges towards the desired allocation position. Where a convergence measure dictates a change in ticket price, application of the convergence measure will result in a change in the ticket price. Where a convergence measure is an improvement in perceived service level, the application of the convergence measure may be the implementation of training programs or more immediate measures such as staff reallocation (to place staff based on experience level) and changes to in-flight meals.

Once a convergence measure has been applied, it is useful to understand whether it has been effective. Thus step 112 involves determining whether the allocation position of the subject allocations provider is converging towards the desired allocation position. This is achieved by identifying one or more further conforming allocations in transaction level data received after applying the at least one convergence measure to the allocations offering, i.e. sales made after application of the convergence measure, determining a new allocation position of the subject allocations provider and comparing the allocation position of the subject allocations provider to the desired allocation position. This results in a before and after picture in which an assessment is made of the change in allocation position of the subject allocations provider after application of the convergence measure or convergence measures.

Where the desired allocations position is improved market share, determining convergence of the allocations position to the desired allocation position involves determining a change in the percentage share of total conforming allocations for the subject allocations providers against the percentage share of total allocations for the at least one of the one or more other allocations providers.

Lastly, convergence measures are subject to change. One convergence measure may work well at a particular time and less well during a different time. It is therefore useful to determine whether the difference between the allocation position and the desired allocation position before application of the convergence measure, when compared with the difference between the allocation position and the desired allocation position after application of the convergence measure, is likely to result in the desired allocation position being reached. In particular, most allocation positions will relate to flights occurring on a fixed date (e.g. 1 Aug. 2015 per FIG. 2), thus the deadline for convergence of the allocation position with the desired allocation position must be on or before that fixed date. If the change in allocation position before and after application of the convergence measure or convergence measures in unlikely to result in the desired convergence of allocation positions, then new convergence measures may be determined.

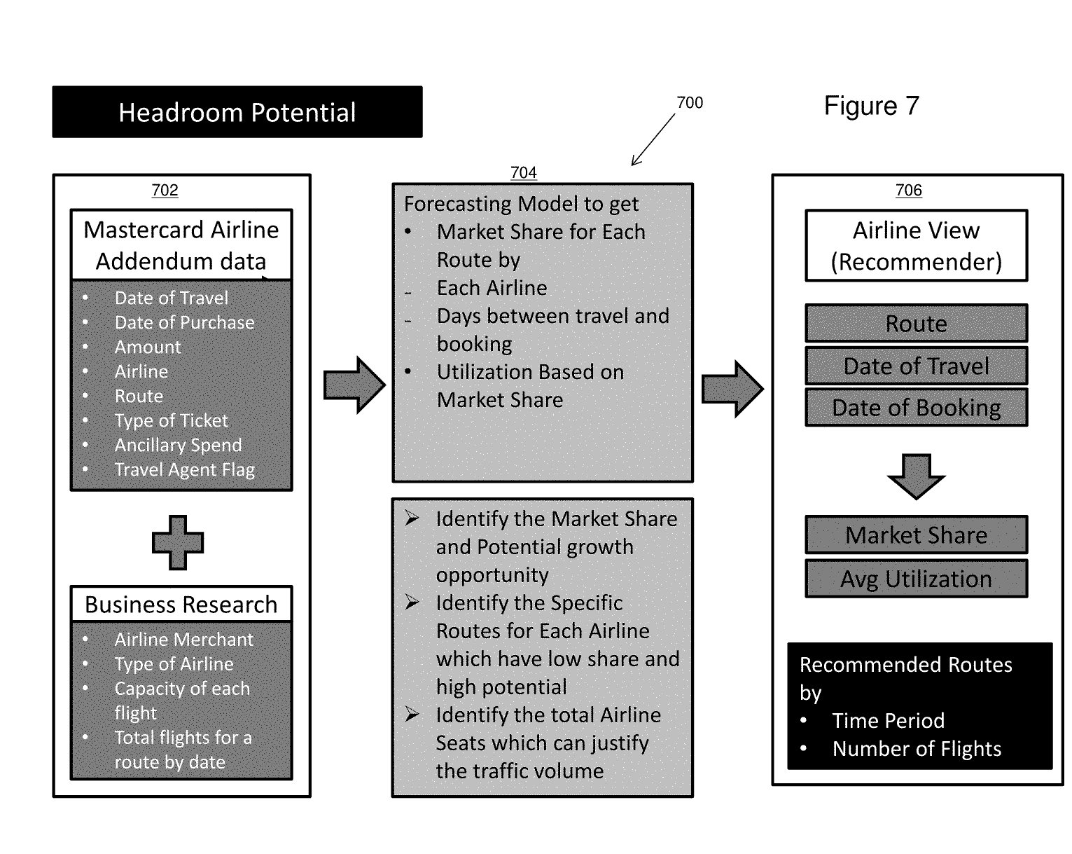

The data flow for the process set out in relation to FIG. 1 is shown in FIG. 7. The data flow 700 involves:
Step 702: the collection of data specific to the circumstances in question;
Step 704: the collection and application of current market data to the data collected at step 702; and
Step 706: the formulation of a route recommendation which will generally be in the form of one or more convergence measures.

At step 702, data relevant to the itinerary data is collected. In other words, rather than collecting bulk data relating to flights, data relevant to the specific itinerary data is collected. This data can be collected from transaction level data and may include:
Date of travel
Date of purchase of ticket/allocation
Transaction amount
Airline or allocations provider
Type of ticket (e.g. first class, business class, Economy Plus, Economy)
Ancillary spend or spend on ancillary provisions
Travel agent flag, being the component of charges directed to travel agent fees

Data from transactions can be supplemented, where necessary, with business research data. All such data is intended to constitute data derivable from transaction level data. The business research data may relate to the business parameters for a particular airline, such as:
Airline merchant or allocations outlet through which the allocations are purchased and confirmed
Type of airline (e.g. budget or premium carrier)
Capacity of each flight
Total flights for a route by date/departure time

This data may also include running and operating costs for each flight or route. In other words, data that is not directly affected by consumer behaviour after a particular flight is advertised may constitute business research data.

After data collection, the data is passed to a modeller at step 704. The modeller receives or formulates allocations positions as necessary, using historical data of similar itineraries, ticket costings and ancillary provisions, as appropriate.

The historical data may be industry wide and date non-specific. Alternatively, the historical data applied to the data acquired in step 702 may be route specific or airline specific, and relate to similar travel dates or travel seasons.

The data generated at step 704 may set out a forecast allocations position at the date of travel (departure time). The data generated at step 704 may also show the development of that allocations position over time, from the current date to the departure time. The format of the data shown in the forecasts may take any desired format, such as utilization or raw numbers (e.g. 102 allocations forecast to be sold by the departure time) or numbers according to capacity (e.g. 93% of capacity forecast to be sold by departure time), against the average ticket cost for all allocations purchased by each particular date.

After the allocations positions have been forecast, the allocations positions are forwarded to a recommender engine for viewing by the airline or another party. The recommender engine identifies the desired parameters, for example, increased market share or increased utilisation of capacity, for each allocation position according to the itinerary data and the date of booking at step 706. The allocations offering can change depending on the date of booking and consumer behaviour. The recommender engine augments the forecast allocations positions with target utilisation data, target market share data or other data as desired by the airline (or third party) and produces a recommendation for moving from the current allocations position of the subject airline to the desired allocations position (e.g. full utilisation or capacity, increased market share or a particular market share). The recommendation may also include suggestions on fleet optimisation, such as the acquisition or disposal of aircraft, the configuration of aircraft and so forth. Where the data flow 700 is used for multiple sets of itinerary data for a particular carrier, the recommender engine may also recommend re-tasking aircraft from one route to another. Thus the data flow 700 augments empirical data of a current position of an airline with historical data and projected trends, to produce an optimum allocations offering to achieve a desired outcome, whether that outcome is a particular market share or rate of utilisation/occupancy.

FIG. 3 shows historical trend data for percentage of tickets booked (of all available tickets for a particular airline or group of airlines) against ticket price and days to departure time. The graph 300 of FIG. 3 shows that as the departure time approaches (moving leftward on the graph 300) the percentage of available tickets diminishes and the price for those available tickets increases. Thus the most profitable tickets are sold closest to the departure time. To decrease the percentage of available tickets further from the departure date a convergence measure may dictate a reduction in average ticket price. The result of that convergence measure may be that a subsequently applied convergence measure, dictating a significant increase in average ticket price, can be used once fewer tickets are available to satisfy demand. On the whole, the application of different convergence measures, and the timing of application of those measures, can be used to achieve different objectives at different times before the departure date. Similarly, the desired allocation position may change depending on the success of a convergence measure. In the example given above, a convergence measure resulting in a reduction of average ticket price may result in rapid ticket sales and thus a convergence towards a desired allocation position of full occupancy, and after a period the desired allocation position may change to being a higher average ticket price, thus a subsequently applied convergence measure may be developed to match the new desired allocation position.

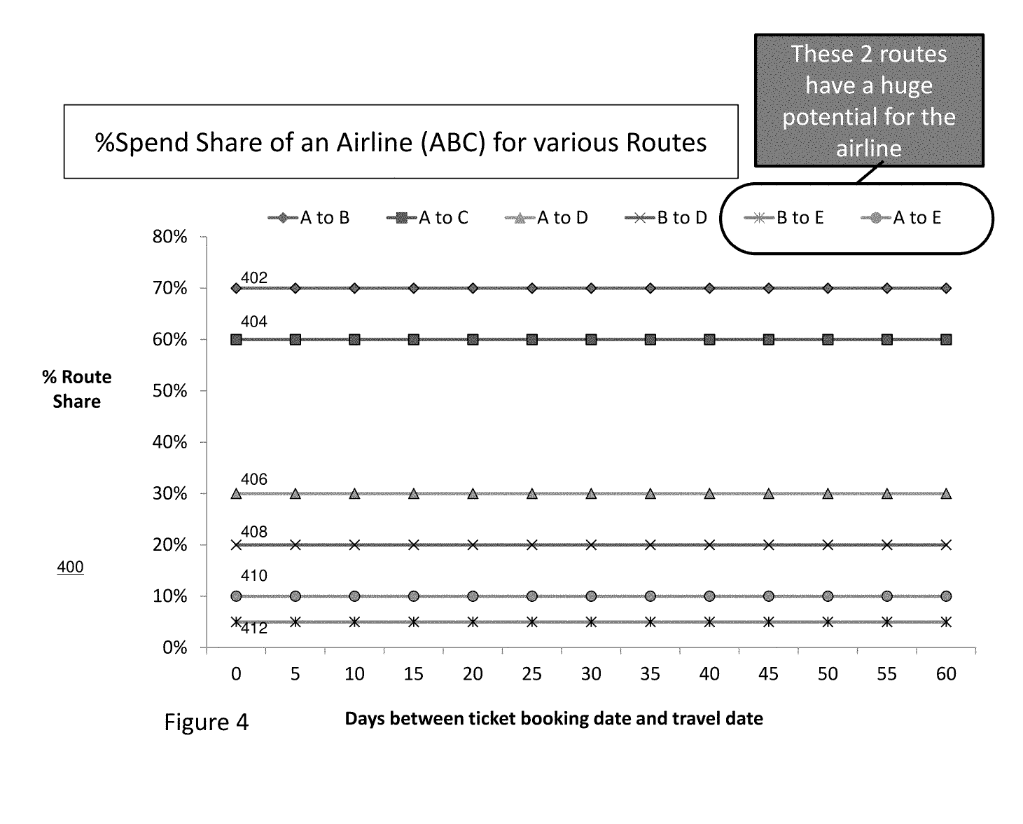

FIG. 4 provides a graphical method for identifying candidate routes for applying the methods taught herein. The graph 400 illustrates the share of consumer spending on allocations on various routes, each route forming a separate line on the graph 400. For route 402, between ports A and B, and route 404, between ports A and C, the subject allocations provider already has a significant share of the consumer spend. Thus improvements in share of consumer spend may be more difficult to achieve for those routes than for routes, 406, 408, 410 and 412. However, profitability may yet be readily improved for seats booked on routes 402 and 404.

It is instead more likely that significant additional consumer spend can be acquired by looking at route 410, between ports B and E, and route 412, between ports A and E, where the subject allocations provider receives around 8% to 10% of consumer spend. To improve the share of consumer spend acquired by the subject allocations provider may warrant the addition of further aircraft to routes 410 and 412, a change in ticket pricing strategy among other convergence measures that may be defined once the desired allocations position is known.

Candidate routes may therefore be selected based on the parameters of the desired allocations position. Where one of the parameters is increased profit then the routes on which the allocations provider supplied more allocations (e.g. seats on aircraft) may be more readily capable of producing results that meet the desired allocations position (i.e. after application of one or more convergence parameters). Where one of the parameters is increased industry market share, then the routes on which the allocations provider satisfies the smallest proportion of the demand for allocations may be the routes most readily capable of producing results that meet the desired allocations position (i.e. after application of one or more convergence parameters).

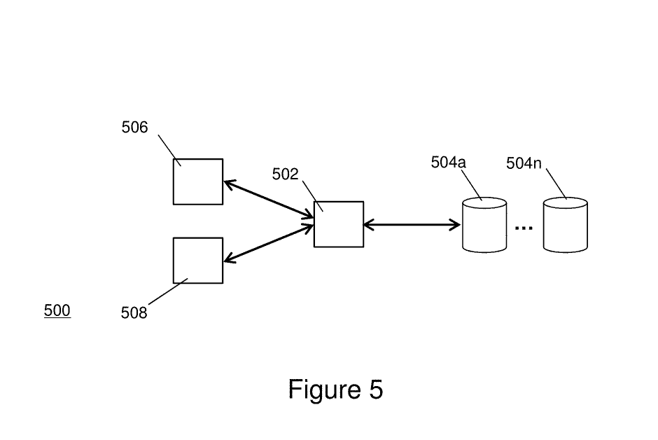

Selection of a candidate route may be made automatically. For example, the computer 502 of FIG. 5 may be used to compare one or more flight routes and/or one or more departure times for a particular route to identify which route might best benefit from application of the method of FIG. 1. A specific route may then be selected by the computer 502 based on one or more parameters, such as the proportion of revenue or income derived from the respective route by the subject allocations provider when compared with all revenue derived from the route, and a number of conforming allocations associated with the subject allocations provider when compared with a total number of conforming allocations. Other parameters may be used for selection as appropriate. The parameter or parameters used for selection may be based on the parameter or parameters from which the desired allocations position is determined.

FIG. 5 shows a schematic of a network-based system 500 for determining a convergence measure for converging an allocation position of a subject allocations provider towards a desired allocation position according to an embodiment of the disclosure. The system 500 comprises a computer 502, one or more databases 504a . . . 504n, a user input module 506 and a user output module 508. Each of the one or more databases 504a . . . 504n is communicatively coupled with the computer 502. The user input module 506 and a user output module 508 may be separate and distinct modules communicatively coupled with the computer 502. Alternatively, the user input module 506 and a user output module 508 may be integrated within a single mobile electronic device (e.g. a mobile phone, a tablet computer, etc.). The mobile electronic device may have appropriate communication modules for wireless communication with the computer 502 via existing communication protocols.

The computer 502 may comprise: at least one processor; and at least one memory including computer program code; the at least one memory and the computer program code configured to, with at least one processor, cause the computer at least to: (A) receive itinerary data comprising route information and an indicative departure time; (B) identify one or more conforming allocations from a plurality of allocations represented by transaction level data (C) determine the allocation position for the subject allocations provider and an allocation position of one or more other allocations providers based on the one or more conforming allocations; and (D) compare the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position. For step (B), the following applies (B)(i) each allocation is associated with a respective allocations offering; (B)(ii) each allocations offering comprises a plurality of parameters including a transaction amount, allocation itinerary data and allocations provider, and the allocation itinerary data comprises allocation route information and a departure time; (B)(iii) each allocation comprises at least three parameters derived from the parameters of the respective allocations offering, the at least three parameters including the transaction amount, allocation itinerary data and allocations provider; (B)(iv) the transaction amount, allocation itinerary data and allocations provider are derivable using the transaction level data; and (B)(v) each conforming allocation comprises allocation route information and departure time matching allocation information and indicative departure time of the itinerary data.

Step (D) may be performed by determining a number of conforming allocations for each allocations provider and comparing the number of conforming allocations for the subject allocations provider against the number of conforming allocations for the at least one of the one or more other allocations providers. The number of conforming allocations in this step may be represented by a ratio of conforming allocations for the respective allocations provider to total available conforming allocations for the respective allocations provider.

Step (D) may instead be performed by comparing a percentage share of total conforming allocations for the subject allocations providers against a percentage share of total allocations for the at least one of the one or more other allocations providers. This may be achieved by (D)(i) applying the at least one convergence measure to the allocations offering associated with the subject allocations provider; and (D)(ii) comparing the allocation position of the subject allocations provider to the desired allocation position by determining a change in the percentage share of total conforming allocations for the subject allocations providers against the percentage share of total allocations for the at least one of the one or more other allocations providers.

Where the transaction amount comprises a ticket price, step (D) may be performed by comparing an average ticket price for all conforming allocations for the subject allocations provider to an average ticket price for all conforming allocations for the at least one of the one or more other allocations providers.

In an implementation, the computer 502 may be further caused to: (E) apply the at least one convergence measure to the allocations offering associated with the subject allocations provider so that the allocation position of the subject allocations provider converges towards the desired allocation position; and/or (F) determine whether the allocation position of the subject allocations provider is converging towards the desired allocation position by identifying one or more further conforming allocations in transaction level data received after applying the at least one convergence measure to the allocations offering associated with the subject allocations provider, and comparing the allocation position of the subject allocations provider to the desired allocation position.

Step (E) may be performed by determining a first difference, being a difference between the allocation position of the subject allocations provider and the desired allocation position by determining before the at least one convergence measure is applied, and comparing the first difference to a second difference, the second difference being a difference between an allocation position of the subject allocations provider and the desired allocation position after the at least one convergence measure is applied. Where this process is used, Step (E) may further involve determining whether the second difference is less than the first difference by an amount that will result in the allocation position of the subject allocations provider converging to the desired allocation position by a fixed date.

The various types of data, e.g. itinerary data, departure times, route data and other data described with reference to transaction level data and allocation data, can be stored on a single database (e.g. 504a), or stored in multiple databases (e.g. wallet credentials are stored on database 504a, payment vehicle credentials are stored on database 504n, etc.). The databases 504a . . . 504n may be realized using cloud computing storage modules and/or dedicated servers communicatively coupled with the computer 502.

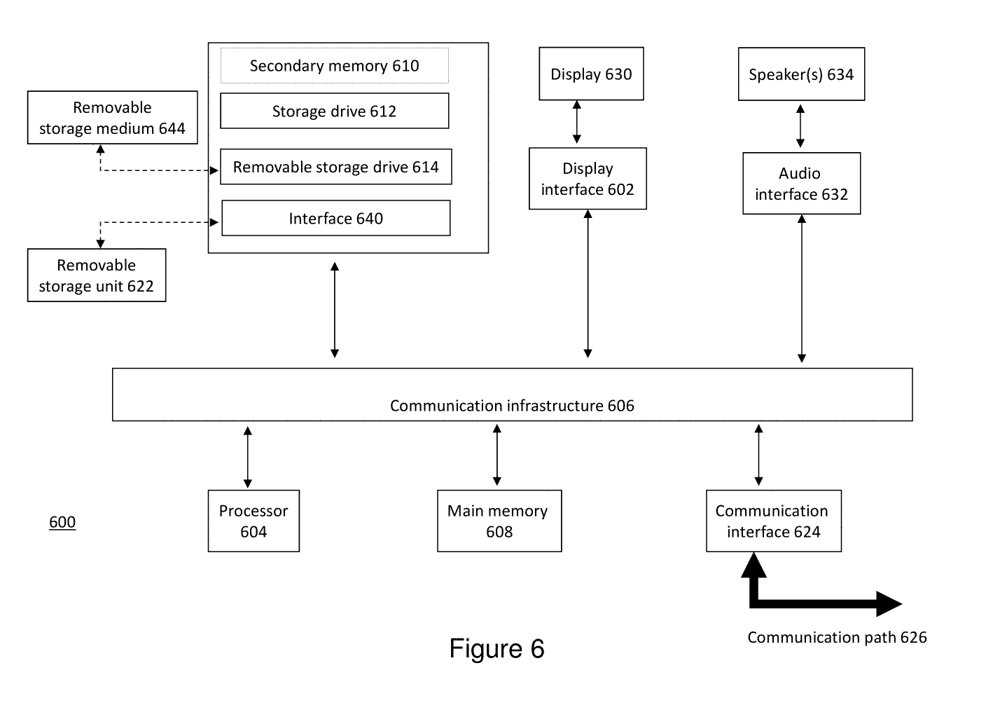

FIG. 6 depicts an exemplary computer/computing device 600, hereinafter interchangeably referred to as a computer system 600, where one or more such computing devices 600 may be used to facilitate execution of the above-described method for determining a convergence measure for converging an allocation position of a subject allocations provider towards a desired allocation position. In addition, one or more components of the computer system 600 may be used to realize the computer 502. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 644 in a well-known manner. The removable storage medium 644 may include magnetic tape, optical disk, non-volatile memory storage medium, or the like, which is read by and written to by removable storage drive 614. As will be appreciated by persons skilled in the relevant art(s), the removable storage medium 644 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 640. Examples of a removable storage unit 622 and interface 640 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 640 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the disclosures, the communication interface 624 permits data to be transferred between the computing device 600 and a data communication network, such as a public data or private data communication network. The communication interface 624 may be used to exchange data between different computing devices 600 which such computing devices 600 form part of an interconnected computer network. Examples of a communication interface 624 can include a modem, a network interface (such as an Ethernet card), a communication port (such as a serial, parallel, printer, GPIB, IEEE 1393, RJ45, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage medium 644, removable storage unit 622, a hard disk installed in storage drive 612, or a carrier wave carrying software over communication path 626 (wireless link or cable) to communication interface 624. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 640. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the computer implemented method as described with respect to FIG. 1. For example, the computing device 600 provides an apparatus for performing a method for determining a convergence measure for converging an allocation position of a subject allocations provider towards a desired allocation position, the apparatus comprising: at least one processor 604, at least one memory 608 including computer program code and at least one communication interface 624.

The at least one memory 608 and the computer program code are configured to, with at least one processor 604, cause the apparatus at least to: receive itinerary data through the communication interface 624, the itinerary data comprising route information and an indicative departure time and identify, using the at least one processor 604, one or more conforming allocations from a plurality of allocations represented by transaction level data. Each allocation is associated with a respective allocations offering and each allocations offering comprises a plurality of parameters including allocation itinerary data and allocations provider, and the allocation itinerary data comprises allocation route information and a departure time. Moreover, each allocation comprises at least three parameters derived from the parameters of the respective allocations offering, the at least three parameters including the transaction amount, allocation itinerary data and allocations provider. In addition, the transaction amount, allocation itinerary data and allocations provider are derivable using the transaction level data. Thus conforming allocations are those for which allocation route information and departure time match the route information and indicative departure time of the itinerary data.

The at least one memory 608 and the computer program code are further configured to cause the at least one processor 604 to determine the allocation position for the subject allocations provider and an allocation position of one or more other allocations providers based on the one or more conforming allocations.

The at least one memory 608 and the computer program code are further configured to cause the at least one processor 604 to compare the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position.

The computing device 600 of FIG. 6 may execute the process shown in FIG. 1 when the computing device 600 executes instructions which may be stored in any one or more of the removable storage medium 644, the removable storage unit 622 and storage drive 612. These components 622, 644 and 612 provide a non-transitory computer readable medium having stored thereon executable instructions for controlling a computer to perform steps comprising: a) receiving itinerary data comprising route information and an indicative departure time; b) identifying one or more conforming allocations from a plurality of allocations represented by transaction level data; c) determining the allocation position for the subject allocations provider and an allocation position of one or more other allocations providers based on the one or more conforming allocations; and d) comparing the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position; and potentially further comprising: e) applying the at least one convergence measure to the allocations offering associated with the subject allocations provider so that the allocation position of the subject allocations provider converges towards the desired allocation position; and f) determining whether the allocation position of the subject allocations provider is converging towards the desired allocation position.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining a convergence measure for converging an allocation position of a subject allocations provider towards a desired allocation position, the method comprising:
receiving itinerary data comprising route information and an indicative departure time;
identifying, by a computing system, one or more conforming allocations from a plurality of allocations represented by transaction level data, wherein:
each allocation is associated with a respective allocations offering;
each allocations offering comprises a plurality of parameters including allocation itinerary data and an associated allocations provider, and the allocation itinerary data comprises allocation route information and a departure time;
each allocation comprises at least three parameters derived from the parameters of the respective allocations offering, the at least three parameters including the transaction amount, allocation itinerary data and allocations provider;
the transaction amount, allocation itinerary data and allocations provider are derivable using the transaction level data; and
each conforming allocation comprises allocation route information and departure time matching the route information and indicative departure time of the itinerary data;
determining, by the computing system, the allocation position for the subject allocations provider and an allocation position of one or more other allocations providers based on the one or more conforming allocations; and
comparing, by the computing system, the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position.

2. The method of claim 1, further comprising applying the at least one convergence measure to the allocations offering associated with the subject allocations provider so that the allocation position of the subject allocations provider converges towards the desired allocation position.

3. The method of claim 2, further comprising determining whether the allocation position of the subject allocations provider is converging towards the desired allocation position by identifying one or more further conforming allocations in transaction level data received after applying the at least one convergence measure to the allocations offering associated with the subject allocations provider, determining a new allocation position of the subject allocations provider and comparing the new allocation position to the desired allocation position.

4. The method of claim 1, wherein comparing the allocation position of the subject allocations provider to the allocation position of at least one of the one or more other allocations providers comprises determining a number of conforming allocations for each allocations provider and comparing the number of conforming allocations for the subject allocations provider against the number of conforming allocations for the at least one of the one or more other allocations providers.

5. The method of claim 4, wherein the number of conforming allocations is represented by a ratio of conforming allocations for the respective allocations provider to total available conforming allocations for all allocations providers.

6. The method of claim 1, wherein comparing the allocation position of the subject allocations provider to the allocation position of at least one of the one or more other allocations providers comprises comparing a percentage share of total conforming allocations for the subject allocations providers against a percentage share of total allocations for the at least one of the one or more other allocations providers.

7. The method of claim 6, wherein the transaction amount comprises a ticket price, and comparing the allocation position of the subject allocations provider to the allocation position of at least one of the one or more other allocations providers comprises comparing an average ticket price for all conforming allocations for the subject allocations provider to an average ticket price for all conforming allocations for the at least one of the one or more other allocations providers.

8. The method of claim 6, further comprising:
applying the at least one convergence measure to the allocations offering associated with the subject allocations provider; and
comparing, by the computing system, the allocation position of the subject allocations provider to the desired allocation position by determining a change in the percentage share of total conforming allocations for the subject allocations providers against the percentage share of total allocations for the at least one of the one or more other allocations providers.

9. The method of claim 8, further comprising automatically identifying the route information of the itinerary data; and
wherein automatically identifying the route information of the itinerary data comprises:
comparing at least one of one or more routes and one or more departure times for each respective route; and
selecting the route information based on at least one of the proportion of revenue derived from the respective route by the subject allocations provider when compared with all revenue derived from the route, and a number of conforming allocations associated with the subject allocations provider when compared with a total number of conforming allocations.

10. (canceled)

11. The method of claim 2, further comprising determining a first difference, being a difference between the allocation position of the subject allocations provider and the desired allocation position before the at least one convergence measure is applied, and comparing the first difference to a second difference, the second difference being a difference between an allocation position of the subject allocations provider and the desired allocation position after the at least one convergence measure is applied.

12. The method of claim 11, further comprising determining whether the second difference is less than the first difference by an amount that will result in the allocation position of the subject allocations provider converging to the desired allocation position by a fixed date.

13. A computer system for determining a convergence measure for converging an allocation position of a subject allocations provider towards a desired allocation position, the computer system comprising:
a memory device for storing data;
a display; and
a processor coupled to the memory device and being configured to:
receive itinerary data comprising route information and an indicative departure time;
identify one or more conforming allocations from a plurality of allocations represented by transaction level data, wherein:
each allocation is associated with a respective allocations offering;
each allocations offering comprises a plurality of parameters including allocation itinerary data and an associated allocations provider, and the allocation itinerary data comprises allocation route information and a departure time;
each allocation comprises at least three parameters derived from the parameters of the respective allocations offering, the at least three parameters including the transaction amount, allocation itinerary data and allocations provider;
the transaction amount, allocation itinerary data and allocations provider are derivable using the transaction level data; and
each conforming allocation comprises allocation route information and departure time matching the route information and indicative departure time of the itinerary data;
determine the allocation position for the subject allocations provider and an allocation position of one or more other allocations providers based on the one or more conforming allocations; and
compare the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position.

14. The computer system according to claim 13, wherein the processor is configured to apply the at least one convergence measure to the allocations offering associated with the subject allocations provider so that the allocation position of the subject allocations provider converges towards the desired allocation position.

15. The computer system according to claim 14, wherein the processor is configured to determine whether the allocation position of the subject allocations provider is converging towards the desired allocation position by identifying one or more further conforming allocations in transaction level data received after applying the at least one convergence measure to the allocations offering associated with the subject allocations provider, determine a new allocation position of the subject allocations provider and compare the new allocation position to the desired allocation position.

16. The computer system according to claim 13, wherein the processor is configured to compare the allocation position of the subject allocations provider to the allocation position of at least one of the one or more other allocations providers by determining a number of conforming allocations for each allocations provider and comparing the number of conforming allocations for the subject allocations provider against the number of conforming allocations for the at least one of the one or more other allocations providers; and/or
wherein the processor is configured to compare the allocation position of the subject allocations provider to the allocation position of at least one of the one or more other allocations providers by comparing a percentage share of total conforming allocations for the subject allocations providers against a percentage share of total allocations for the at least one of the one or more other allocations providers.

17. (canceled)

18. A non-transitory computer readable storage media including computer-executable instructions for determining a convergence measure for converging an allocation position of a subject allocations provider towards a desired allocation position, which when executed by a processor, cause the processor to:
receive itinerary data comprising route information and an indicative departure time;
identify one or more conforming allocations from a plurality of allocations represented by transaction level data, wherein:
each allocation is associated with a respective allocations offering;
each allocations offering comprises a plurality of parameters including allocation itinerary data and an associated allocations provider, and the allocation itinerary data comprises allocation route information and a departure time;
each allocation comprises at least three parameters derived from the parameters of the respective allocations offering, the at least three parameters including the transaction amount, allocation itinerary data and allocations provider;
the transaction amount, allocation itinerary data and allocations provider are derivable using the transaction level data; and
each conforming allocation comprises allocation route information and departure time matching the route information and indicative departure time of the itinerary data;
determine the allocation position for the subject allocations provider and an allocation position of one or more other allocations providers based on the one or more conforming allocations; and
compare the allocation position of the subject allocations provider to the allocation position of at least one of the one or more other allocations providers to identify at least one convergence measure for adjusting one or more parameters of an allocations offering associated with the subject allocations provider so that the allocation position of the subject allocations provider converges towards the desired allocation position.

19. The non-transitory computer readable storage media according to claim 18, wherein the computer-executable instructions include at least one code segment executable by the processor to instruct the processor to apply the at least one convergence measure to the allocations offering associated with the subject allocations provider so that the allocation position of the subject allocations provider converges towards the desired allocation position.

20. The non-transitory computer readable storage media according to claim 18, comprising wherein the computer-executable instructions include at least one code segment executable by the processor to instruct the processor to determine whether the allocation position of the subject allocations provider is converging towards the desired allocation position by identifying one or more further conforming allocations in transaction level data received after applying the at least one convergence measure to the allocations offering associated with the subject allocations provider, determine a new allocation position of the subject allocations provider and compare the new allocation position to the desired allocation position.

21. The non-transitory computer readable storage media according to claim 18, wherein the computer-executable instructions include at least one code segment executable by the processor to instruct the processor to compare the allocation position of the subject allocations provider to the allocation position of at least one of the one or more other allocations providers by determining a number of conforming allocations for each allocations provider and comparing the number of conforming allocations for the subject allocations provider against the number of conforming allocations for the at least one of the one or more other allocations providers.

22. The non-transitory computer readable storage media according to claim 18, wherein the computer-executable instructions include at least one code segment executable by the processor to instruct the processor to compare the allocation position of the subject allocations provider to the allocation position of at least one of the one or more other allocations providers by comparing a percentage share of total conforming allocations for the subject allocations providers against a percentage share of total allocations for the at least one of the one or more other allocations providers
